(19) United States
(12) Patent Application Publication
(10) Pub. No.: US 2026/0349378 A1
(43) Pub. Date: Nov. 5, 2026

(54) IMAGE FORMING APPARATUS

(71) Applicant: KYOCERA Document Solutions Inc., Osaka (JP)

(72) Inventors: Keisuke OBA, Osaka (JP); Kazuaki FUJIWARA, Osaka (JP)

(73) Assignee: KYOCERA Document Solutions Inc., Osaka (JP)

(21) Appl. No.: 19/657,453

(22) Filed: Apr. 24, 2026

(30) Foreign Application Priority Data
May 2, 2025 (JP) 2025-076653

(51) Int. Cl. G03G 15/00; G03G 5/082; G03G 15/01; G03G 15/09

(52) U.S. Cl. CPC G03G 15/5004; G03G 5/08214; G03G 15/0121; G03G 15/0126; G03G 15/0131; G03G 15/0189; G03G 15/0907; G03G 15/80; G03G 2215/0609

(57) ABSTRACT

If a developing voltage determined in a calibration mode is equal to or less than a predetermined value, a control portion does not correct image formation conditions based on a sensing result from a sensing portion and if the developing voltage determined in the calibration mode is higher than the predetermined value, the control portion corrects the image formation conditions based on the sensing result from the sensing portion. The image formation conditions are corrected based on the sensing result from the sensing portion.

### INCORPORATION BY REFERENCE

This application is based on and claims the benefit of priority from Japanese Patent Application No. 2025-076653 filed on May 2, 2025, the contents of which are hereby incorporated by reference.

### BACKGROUND

The present disclosure relates to an image forming apparatus, such as a copier, a printer, a facsimile, or a multifunction peripheral incorporating the functions of all those, that is provided with an image carrying member.

A conventional image forming apparatus includes an image forming portion, a transfer member, a developing voltage power supply, a transfer voltage power supply, and a control portion. The image forming portion includes an image carrying member, a charging device, an exposure device, and a developing device. The developing device is disposed to face the image carrying member, has a developer carrying member carrying developer, and forms a toner image by attaching toner to an electrostatic latent image formed on the image carrying member.

The transfer member is disposed to face the image carrying member and is fed with a predetermined transfer voltage to transfer to a transfer destination member the toner image formed on the image carrying member. The developing voltage power supply applies a developing voltage to the developer carrying member. The transfer voltage power supply applies a transfer voltage to the transfer member to pass a transfer current across the transfer member.

The control portion can perform an image formation mode in which image formation is performed under predetermined image formation conditions including a developing voltage and a transfer voltage, and a calibration mode in which the image formation conditions are corrected to keep the image quality of the toner image. Based on the developing voltage determined in the calibration mode, the control portion further corrects the transfer voltage applied in the image formation mode.

In a conventional image forming apparatus, the charge amount of developer changes depending on the environment (temperature, humidity) around the apparatus body. If the charge amount of developer increases, the developing voltage is set high to ensure the desired image density. Here, the amount of carrier flying from the developer carrying member may also increase and, this may cause white spots starting with carrier.

On the other hand, setting the transfer voltage (transfer current) high helps prevent white spots starting with carrier. However, setting the transfer voltage (transfer current) high gives electric charge to toner and increases its charge amount. As a result, when images of two or more colors are transferred to be superimposed together, transfer performance may be impaired for the second color, and this may result in a rough image.

In view of the above-mentioned problems, an object of the present disclosure is to provide an image forming apparatus that helps prevent an image with white spots and a rough image.

### SUMMARY

To achieve the above object, according to a first configuration of the present disclosure, an image forming apparatus includes: an image forming portion including an image carrying member that has a photosensitive layer on its surface, a charging device that electrostatically charges the image carrying member, an exposure device that forms an electrostatic latent image by exposing to light the image carrying member electrostatically charged by the charging device, and a developing device that is disposed to face the image carrying member, that has a developer carrying member carrying two-component developer containing magnetic carrier and toner, and that forms a toner image by attaching the toner to the electrostatic latent image formed on the image carrying member; a transfer member that is disposed to face the image carrying member and that is fed with a predetermined transfer voltage to transfer to a transfer destination member the toner image formed on the image carrying member; a sensing portion that senses humidity around the apparatus body; a developing voltage power supply that applies a developing voltage to the developer carrying member, a transfer voltage power supply that applies a transfer voltage to the transfer member to pass a transfer current across the transfer member; and a control portion that controls the image forming portion, the sensing portion, the developing voltage power supply, and the transfer voltage power supply. The control portion can perform a calibration mode in which predetermined image formation conditions are determined to keep image quality of a toner image, and an image formation mode in which image formation is performed while the image formation conditions determined in the calibration mode are corrected. If the developing voltage determined in the calibration mode is equal to or less than a predetermined value, the control portion does not correct the image formation conditions based on the sensing result from the sensing portion and if the developing voltage determined in the calibration mode is higher than the predetermined value, the control portion corrects the image formation conditions based on the sensing result from the sensing portion. The image formation conditions are corrected based on the sensing result from the sensing portion.

Further objects of the present disclosure and specific advantages achieved according to the present disclosure become more apparent from the following description of the embodiment.

### BRIEF DESCRIPTION OF THE DRAWINGS

FIG. 1 is a side sectional view showing the internal construction of an image forming apparatus 100 according to an embodiment of the present disclosure.

FIG. 2 is a schematic sectional view of primary transfer rollers 6a to 6d and photosensitive drums 1a to 1d in the image forming apparatus 100 according to the embodiment of the present disclosure.

FIG. 3 is a side sectional view of a developing device 3a incorporated in the image forming apparatus 100 according to the embodiment of the present disclosure.

FIG. 4 is an enlarged part view around an image forming portion Pa, also showing control paths in the image forming apparatus 100 according to the embodiment of the present disclosure.

FIG. 5 is a graph showing the relationship between absolute humidity and transfer current.

FIG. 6 is a graph showing the relationship between absolute humidity and an upper limit value of a developing voltage.

FIG. 7 is a graph showing the relationship between absolute humidity and an upper limit value of the transfer current.

FIG. 8 is a graph showing the relationship between developing voltage and transfer current.

FIG. 9 is a graph showing the relationship between surface resistance value and correction amount.

FIG. 10 is a graph showing the relationship between developing voltage and transfer current.

### DETAILED DESCRIPTION

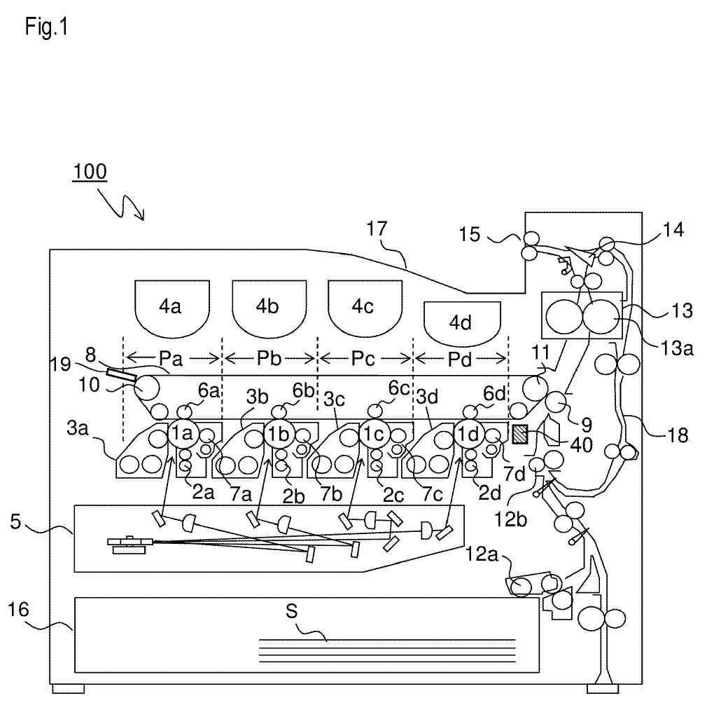

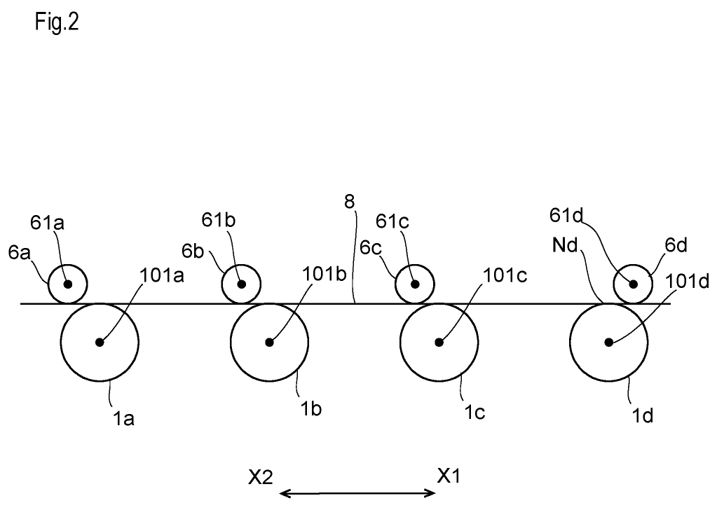

An embodiment of the present disclosure will be described below with reference to the accompanying drawings. FIG. 1 is a side sectional view showing the internal construction of an image forming apparatus 100 according to the embodiment of the present disclosure. FIG. 2 is a schematic sectional view of primary transfer rollers 6a to 6d and photosensitive drums 1a to 1d.

The image forming apparatus 100 includes image forming portions Pa to Pd, an image density sensor 40, and primary transfer rollers (transfer members) 6a to 6d.

In a body of the image forming apparatus 100 (here, a color printer), four image forming portions Pa, Pb, Pc, and Pd are arranged in this order from upstream (left side in FIG. 1) in the conveying direction. These image forming portions Pa to Pd are provided for images of four different colors (yellow, cyan, magenta and black), and sequentially form a yellow, a cyan, a magenta, and a black image respectively, each through the processes of electrostatic charging, exposure to light, image development, and image transfer.

These image forming portions Pa to Pd include photosensitive drums (image carrying members) 1a to 1d that carry visible images (toner images) of the different colors, charging devices 2a to 2d, an exposure device 5, and developing devices 3a to 3d. Furthermore, an intermediate transfer belt (transfer destination member) 8 that rotates counterclockwise in FIG. 1 by being driven by a driving means (not illustrated) is provided adjacent to these image forming portions Pa to Pd.

The primary transfer rollers (transfer members) 6a to 6d are disposed to face the photosensitive drums (image carrying members) 1a to 1d and are fed with predetermined transfer voltages to transfer the visible images (toner images) of the different colors formed on the photosensitive drums (image carrying members) 1a to 1d to the intermediate transfer belt (transfer destination member) 8. As a result, the toner images formed on the photosensitive drums 1a to 1d are primarily transferred sequentially to the intermediate transfer belt (transfer destination member) 8, which moves while in contact with the photosensitive drums 1a to 1d, so as to be superimposed on each other.

In the embodiment, the photosensitive drum (image carrying member) 1d disposed most downstream X1 in the traveling direction of the intermediate transfer belt (transfer destination member) 8 develops a black toner image. The rotation shaft 61a to 61c of at least one of the primary transfer rollers 6a to 6c disposed upstream X2 of the primary transfer roller 6d disposed most downstream X1 in the traveling direction of the intermediate transfer belt (transfer destination member) 8 is offset upstream in the traveling direction of the intermediate transfer belt (transfer destination member) 8 from right above the rotation shaft 101a to 101c of the corresponding photosensitive drum 1a to 1c.

More specifically, the rotation shaft 61d of the primary transfer roller 6d is offset downstream X1 from right above the rotation shaft 101d of the corresponding photosensitive drum 1d (see FIG. 2). The rotation shafts 61a to 61c of the primary transfer rollers 6a to 6c disposed upstream X2 of the primary transfer roller 6d are offset upstream X2 from right above the rotation shafts 101a to 101c of the corresponding photosensitive drums 1a to 1c. This helps prevent color spots starting with carrier.

The toner images primarily transferred to the intermediate transfer belt (transfer destination member) 8 are secondarily transferred to a sheet S as one example of a recording medium by a secondary transfer roller 9. The sheet S to which the toner images are to be secondarily transferred is stored in a sheet cassette 16 disposed in a lower part of the body of the image forming apparatus 100. The sheet S is conveyed to a nip portion between the secondary transfer roller 9 and a driving roller 11 for the intermediate transfer belt 8 via a sheet feed roller 12a and a pair of registration rollers 12b.

Used as the intermediate transfer belt 8 is a sheet of a dielectric resin, typically a belt with no seams (seamless belt). Downstream of the secondary transfer roller 9, a blade-form belt cleaner 19 is disposed for removing the toner and the like remaining on the surface of the intermediate transfer belt 8.

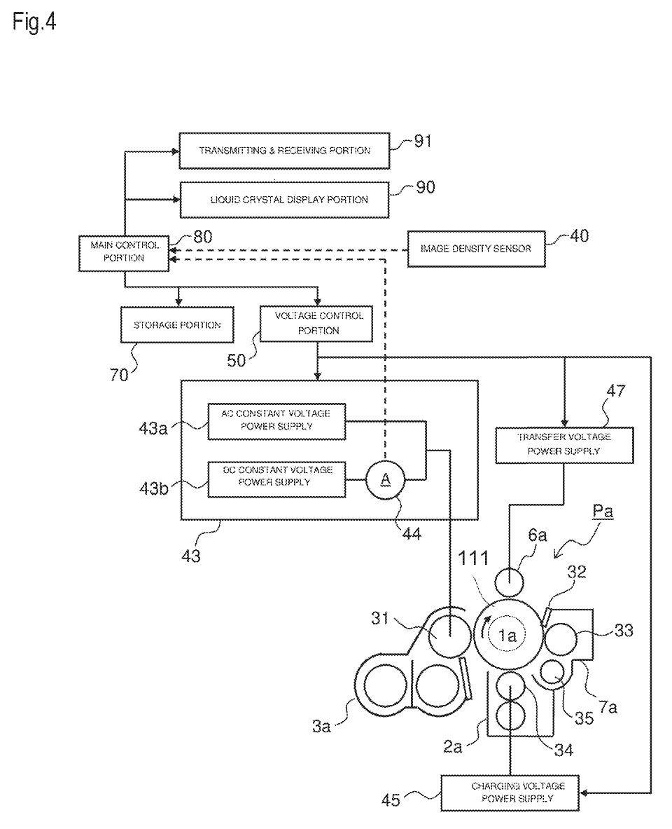

The photosensitive drums (image carrying members) 1a to 1d have a photosensitive layer 111 formed on their surfaces (see FIG. 4). In the embodiment, the photosensitive drums (image carrying members) 1a to 1d have the photosensitive layer 111 formed on the surface of a cylinder made of aluminum, and the photosensitive layer 111 is formed by vapor deposition of amorphous silicon, which is a positively chargeable photoconductor. That is, the photosensitive layer 111 is a positively chargeable single layer type and is made of amorphous silicon.

The charging devices 2a to 2d have charging rollers (charging members) 34 that electrostatically charge the photosensitive drums (image carrying members) 1a to 1d. These charging rollers 34 are disposed to face the photosensitive drums (image carrying members) 1a to 1d to electrostatically charge them. The charging rollers 34 are formed by, for example, covering a metal base with a layer of epichlorohydrin rubber, which is a conductive elastic material. In the embodiment, the charging rollers 34 are in contact with the photosensitive drums 1a to 1d. The charging rollers 34 may not be in contact with the photosensitive drums 1a to 1d.

The exposure device 5 shines light onto the photosensitive drums (image carrying members) 1a to 1d electrostatically charged by the charging devices 2a to 2d to form on them electrostatic latent images.

The developing devices 3a to 3d have developing rollers (developer carrying members) 31. The developing rollers (developer carrying members) 31 are disposed to face the photosensitive drums (image carrying members) 1a to 1d and carry two-component developer containing magnetic carrier and toner. The developing devices 3a to 3d apply predetermined developing voltages to the developing rollers (developer carrying members) 31 to form the toner images by attaching toner to the electrostatic latent images formed on the photosensitive drums (image carrying members) 1a to 1d.

When image data is fed in from a host device such as a personal computer, first, the surfaces of the photosensitive drums 1a to 1d are electrostatically charged uniformly by the charging devices 2a to 2d. After that, the exposure device 5 shines light according to the image data onto the photosensitive drums 1a to 1d to form on them electrostatic latent images corresponding to the image data.

The developing devices 3a to 3d are loaded with predetermined amounts of two-component developer containing yellow, cyan, magenta, and black toner. The toner in the developer is supplied to the photosensitive drums 1a to 1d by the developing devices 3a to 3d and attaches to them electrostatically. This forms toner images corresponding to the electrostatic latent images formed by exposure to light from the exposure device 5.

Then, primary transfer rollers 6a to 6d produce electric fields with a predetermined transfer voltage between themselves and the photosensitive drums 1a to 1d, and the yellow, cyan, magenta, and black toner images on the photosensitive drums 1a to 1d are primarily transferred to the intermediate transfer belt 8. These images of the four colors are formed in a predetermined positional relationship previously determined to form a predetermined full color image. After that, in preparation for the subsequent formation of new electrostatic latent images, the toner and the like remaining on the surfaces of the photosensitive drums 1a to 1d after primary transfer are removed by cleaning devices 7a to 7d.

The intermediate transfer belt (transfer destination member) 8 is stretched across a driven roller 10 at the upstream side and the driving roller 11 at the downstream side. When the intermediate transfer belt 8 starts to rotate counterclockwise as the driving roller 11 is rotated by a driving motor (not illustrated), a sheet S is conveyed, with predetermined timing, from the pair of registration rollers 12b to the nip portion (secondary transfer nip portion) between the driving roller 11 and the secondary transfer roller 9 adjacent to it and the full color image on the intermediate transfer belt 8 is secondarily transferred to the sheet S. The sheet S having the toner images secondarily transferred to it is conveyed to a fixing portion 13.

The sheet S conveyed to the fixing portion 13 is heated and pressed by a pair of fixing rollers 13a such that the toner images are fixed to the surface of the sheet S to form the predetermined full color image. The sheet S having the full color image formed on it has its conveying direction switched by a branch portion 14 which branches into multiple directions and is then discharged to a discharge tray 17 by a pair of discharge rollers 15 as it is (or after being sent to a duplex conveying passage 18 to have images formed on both sides).

The image density sensor 40 is disposed at a position facing the driving roller 11 across the intermediate transfer belt 8. Used as the image density sensor 40 is generally an optical sensor comprising a light emitting element such as an LED and a light receiving element such as a photodiode. When the amount of toner adhered to the intermediate transfer belt 8 is measured, shining measurement light from the light emitting element to reference images formed on the intermediate transfer belt 8 results in the measurement light striking the light receiving element as light reflected from the toner and light reflected from the surface of the belt.

The light reflected from the toner and the surface of the belt includes specularly reflected light and diffusely reflected light. The specularly and diffusely reflected light are split by a polarizing splitter prism and then each enter a separate light receiving element. The light receiving elements photoelectrically convert the received specularly and diffusely reflected light, and output signals to a main control portion 80 (see FIG. 4). Then, the density of the toner image is sensed based on the change of the characteristics of the output signals corresponding to the specularly and diffusely reflected light.

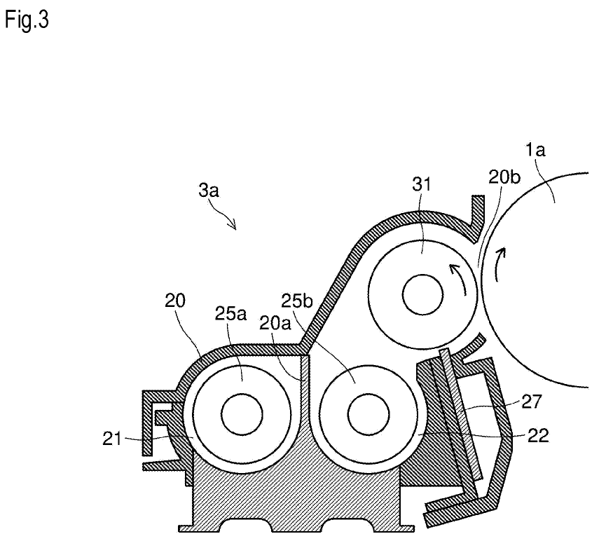

FIG. 3 is a side sectional view of the developing device 3a incorporated in the image forming apparatus 100. While the following description deals with, as an example, the developing device 3a disposed in the image forming portion Pa in FIG. 1, since the developing devices 3b to 3d disposed in the image forming portions Pb to Pd have a basically similar configuration, no overlapping description will be repeated.

As shown in FIG. 3, the developing device 3a includes a developing container 20 that stores two-component developer (hereinafter, referred to simply as developer) containing magnetic carrier and toner, and the developing container 20 is divided into a stirring conveying chamber 21 and a supplying conveying chamber 22 with a partition wall 20a. In the stirring conveying chamber 21 and the supplying conveying chamber 22, a stirring conveying screw 25a and a supplying conveying screw 25b, respectively, are rotatably disposed that mix and stir the toner supplied from a toner container 4a (see FIG. 1) with the magnetic carrier to electrostatically charge them.

Then, by the stirring conveying screw 25a and the supplying conveying screw 25b, the developer is conveyed along the axial direction (the direction perpendicular to the plane of FIG. 3) while being stirred, and circulates between the stirring conveying chamber 21 and the supplying conveying chamber 22 via developer passages, of which neither is illustrated, formed in opposite end parts of the partition wall 20a. That is, the stirring conveying chamber 21, the supplying conveying chamber 22, and the developer passages constitute a circulation passage for developer in the developing container 20.

The developing container 20 extends diagonally to the upper right in FIG. 3, and in the developing container 20, diagonally to the upper right of the supplying conveying screw 25b, the developing roller (developer carrying member) 31 is disposed. Part of the outer circumferential surface of the developing roller 31 is exposed through an opening 20b in the developing container 20 and faces the photosensitive drum 1a. The developing roller 31 rotates counterclockwise in FIG. 3.

The developing roller 31 is configured with a cylindrical developing sleeve that rotates counterclockwise in FIG. 3, and a magnet (not illustrated) with a plurality of magnetic poles fixed in the developing sleeve. While a developing sleeve with a knurled surface is used here, it is also possible to use a sleeve with a large number of depressions (dimples) formed in its surface, one with a blasted surface, one subjected to knurling, depression formation, and in addition blasting, or one subjected to plating.

Furthermore, a regulating blade 27 is attached to the developing container 20 along the longitudinal direction of the developing roller 31 (the direction perpendicular to the plane of FIG. 3). A small clearance (gap) is formed between the tip end of the regulating blade 27 and the surface of the developing roller 31.

FIG. 4 is an enlarged part view around the image forming portion Pa, also showing control paths in the developing device 3a. While the following description deals with the configuration of the image forming portion Pa and the control paths in the developing devices 3a, since the configuration of the image forming portions Pb to Pd and the control paths in the developing devices 3b to 3d are similar, no overlapping description will be repeated.

The image forming apparatus 100 further includes a developing voltage power supply 43, a charging voltage power supply 45, a transfer voltage power supply 47, the main control portion (control portion) 80, an environment sensing portion (sensing portion) 46, a liquid crystal display portion 90, a transmitting and receiving portion 91, a storage portion 70, and a voltage control portion 50.

The developing voltage power supply 43 is connected to the developing roller 31. The developing voltage power supply 43 includes an AC constant voltage power supply 43a and a DC constant voltage power supply 43b. The AC constant voltage power supply 43a outputs a sinusoidal AC voltage generated from a DC voltage that has been pulse-modulated with a step-up transformer (not illustrated). The DC constant voltage power supply 43b outputs a DC voltage resulting from rectifying the sinusoidal AC voltage generated from the DC voltage that has been pulse-modulated with the step-up transformer.

During image formation, the developing voltage power supply 43 applies from the AC and DC constant voltage power supplies 43a and 43b to the developing roller (developer carrying member) 31 a developing voltage having an AC voltage Vac superimposed on a DC voltage Vdc. Applying the developing voltage to the developing roller 31 causes toner to fly from the developing roller 31 to the photosensitive drum 1a under a potential difference between the developing roller 31 and a surface potential of the photosensitive drum 1a, and thereby the electrostatic latent image (exposed part) on the photosensitive drum 1a is developed. Here, applying the developing voltage having the AC voltage Vac superimposed on the DC voltage Vdc facilitates control of development with toner during image formation, thereby improving image quality. While in the embodiment the developing voltage has the AC voltage Vac superimposed on the DC voltage Vdc, it may instead be the DC voltage Vdc alone.

A developing current sensing portion 44 senses a developing current (developing DC current) flowing between the developing roller (developer carrying member) 31 and the photosensitive drum (image carrying member) 1a. Specifically, when the developing voltage is applied to the developing roller (developer carrying member) 31, the developing current sensing portion 44 senses a DC component (developing DC current) in the developing current flowing between the developing roller 31 and the photosensitive drum 1a. Furthermore, the developing current sensing portion 44 senses a DC component in a fog toner current when, with the surface potential of the photosensitive drum (image carrying member) 1a at zero, the developing voltage applied to the developing roller 31 is set to zero.

The charging voltage power supply 45 applies a charging voltage to the charging roller (charging member) 34 in the charging device 2a. The charging voltage is a voltage having an AC voltage superimposed on a DC voltage. Changing the charging voltage allows the developing potential difference V0-Vdc between the surface potential V0 of the photosensitive drum 1a and a developing DC voltage (the DC component in the developing voltage applied to the developing roller 31) Vdc to be adjusted to a predetermined value. The charging voltage applied may instead be the DC voltage alone.

The photosensitive layer 111 on the photosensitive drum 1a is formed by vapor deposition of amorphous silicon, which is a positively chargeable photoconductor, and has a high dielectric constant. Thus, an uneven surface potential of the photosensitive drum 1a may cause uneven image density in the developed toner image. In contrast, applying the charging voltage containing the superimposed AC voltage helps prevent uneven surface potential and helps control the level of the surface potential with the DC voltage contained in the transfer voltage.

The transfer voltage power supply 47 applies a primary transfer voltage (transfer voltage) and a secondary transfer voltage to the primary transfer rollers (transfer members) 6a to 6d and to the secondary transfer roller 9 respectively (see FIG. 1). That is, the transfer voltage power supply 47 applies the primary transfer voltage (transfer voltage) to the primary transfer rollers (transfer members) 6a to 6d to pass a primary transfer current (transfer current) across the primary transfer rollers (transfer members) 6a to 6d.

The cleaning device 7a includes a cleaning blade 32 that removes the toner remaining on the surface of the photosensitive drum 1a, a rubbing roller 33 that removes the toner remaining on the surface of the photosensitive drum 1a and in addition rubs and thereby polishes that surface, and a conveying spiral 35 that discharges out of the cleaning device 7a the toner removed from the photosensitive drum 1a by the cleaning blade 32 and the rubbing roller 33.

The main control portion 80 is configured with a CPU or the like. The main control portion 80 is connected to the storage portion 70 comprising a ROM, a RAM, and the like. Based on control programs and control data stored in the storage portion 70, the main control portion 80 controls different parts of the image forming apparatus 100 (charging devices 2a to 2d, developing devices 3a to 3d, exposure device 5, primary transfer rollers 6a to 6d, cleaning devices 7a to 7d, secondary transfer roller 9, fixing portion 13, developing voltage power supply 43, charging voltage power supply 45, transfer voltage power supply 47, developing current sensing portion 44, environment sensing portion (sensing portion) 46, voltage control portion 50 and the like). That is, the main control portion (control portion) 80 controls the image forming portions Pa to Pd, the environment sensing portion (sensing portion) 46, the developing voltage power supply 43, and the transfer voltage power supply 47.

The voltage control portion 50 controls the developing voltage power supply 43 that applies the developing voltage to the developing roller 31, the charging voltage power supply 45 that applies the charging voltage to the charging roller 34, and the transfer voltage power supply 47 that applies the transfer voltages to the primary transfer rollers 6a to 6d and to the secondary transfer roller 9. The voltage control portion 50 may be configured as control programs stored in the storage portion 70.

The liquid crystal display portion 90 and the transmitting and receiving portion 91 are connected to the main control portion 80. The liquid crystal display portion 90 functions as a touch panel for the user to make various settings for the image forming apparatus 100 and in addition indicates the status of the image forming apparatus 100, the progress of image formation, and the number of printed sheets. The transmitting and receiving portion 91 communicates with the outside via a telephone or internet network.

The environment sensing portion (sensing portion) 46 senses the temperature and humidity around the apparatus body of the image forming apparatus 100. As the environment around the apparatus body of the image forming apparatus 100 (i.e., temperature, humidity) changes, the resistances of the primary transfer rollers 6a to 6d change.

Setting the developing voltage high ensures a desired image density. That, however, may increase the amount of carrier flying from the developing sleeve (developing roller 31) and cause white spots starting with carrier. In contrast, setting the transfer voltage (transfer current) high helps prevent white spots starting with carrier.

On the other hand, setting the transfer voltage (transfer current) high gives electric charge to toner and increases its charge amount. Furthermore, in intermittent operation at a low printing rate, accelerated deterioration of toner accelerates the toner charge amount. As a result, when images of two or more colors are transferred to be superimposed together, transfer performance may be impaired for the second color, and this may result in a rough image. Furthermore, accelerated deterioration of the primary transfer rollers (transfer members) 6a to 6d accelerates the increase in their resistance. Moreover, unless a large transformer is provided in the transfer voltage power supply 47, a desired transfer voltage may not be applied.

In the embodiment, to cope with these problems, the main control portion (control portion) 80 can perform a calibration mode and an image formation mode. In the calibration mode, predetermined image formation conditions are determined to keep the image quality (image density) of the toner image. In the image formation mode, image formation is performed while the image formation conditions determined in the calibration mode are corrected based on the sensing results from the environment sensing portion (sensing portion) 46. The calibration mode is a mode performed separately from the normal image formation mode.

For example, when the calibration mode is performed, a reference image (toner patch) is formed by the developing devices (3a to 3d), and based on the density of the reference image sensed by the image density sensor (density sensing device) 40, the developing voltage is determined. The calibration mode is performed, for example, when the cumulative number of sheets printed after the previously performed calibration mode is equal to or more than a predetermined number.

In the image formation mode, image formation is performed while the developing voltage determined in the calibration mode is corrected based on the sensing result from the environment sensing portion (sensing portion) 46. Furthermore, when the image formation mode is performed, the transfer voltage (transfer current) is determined based on the developing voltage determined in the calibration mode, and image formation is performed while the determined transfer voltage is corrected based on the sensing result from the environment sensing portion (sensing portion) 46.

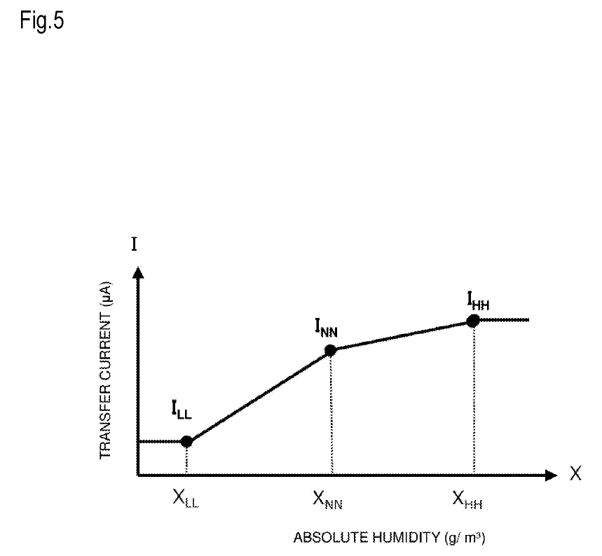

FIG. 5 is a graph showing the relationship between absolute humidity (g/ m³) and transfer current (μA). The resistance value of the primary transfer rollers 6a to 6d increases as the ambient humidity decreases, and the current flowing into the region other than the patch image decreases. Thus, it is preferable that the transfer voltage (transfer current) be corrected to be lower as the ambient humidity decreases. Correcting the transfer voltage (transfer current) to make it lower helps prevent an increase in the toner charge amount and thereby prevent a rough image.

On the other hand, the resistance value of the primary transfer rollers 6a to 6d decreases as the ambient humidity increases, and the current flowing into the region other than the patch image increases. Thus, it is preferable that the transfer voltage (transfer current) be corrected to be higher as the ambient humidity increases. Correcting the transfer voltage (transfer current) to make it higher helps prevent lateral displacement of the patch image during transfer. In a high-humidity environment, the toner charge amount is unlikely to increase. Thus, even if the transfer voltage is corrected to be higher, the increase in the toner charge amount has little effect.

In the embodiment, when the developing voltage determined in the calibration mode is equal to or less than a predetermined value, the image formation conditions (transfer current) are not corrected based on the sensing result from the environment sensing portion (sensing portion) 46. This is because the minimum transfer current required to transfer toner from the photosensitive drums 1a to 1d to the intermediate transfer belt 8 does not depend on the toner charge amount for development.

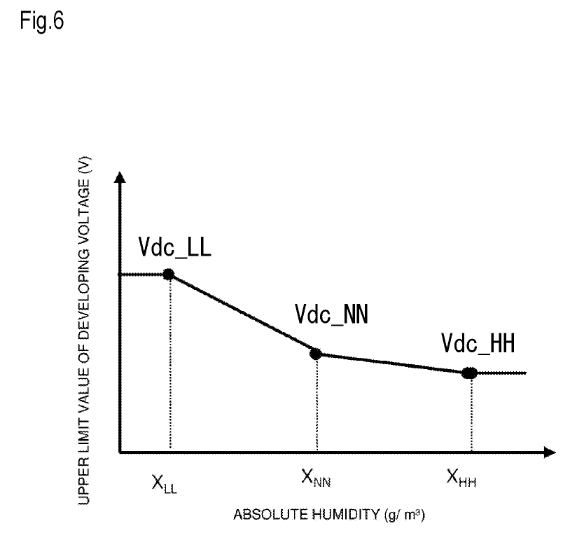

FIG. 6 is a graph showing the relationship between absolute humidity (g/ m³) and the upper limit value of the developing voltage. When the image formation mode is performed, based on the sensing result from the environment sensing portion (sensing portion) 46, the upper limit value of the developing voltage is set. This allows the setting of the upper limit value of the developing voltage according to the carrier resistance that changes with the ambient temperature and humidity. It is thus possible to suppress the flying of carrier to the photosensitive drum 1a and thereby alleviate impairment of transfer performance due to carrier. This makes it possible to prevent white spots around carrier.

Specifically, as the ambient temperature and humidity decrease, the upper limit value of the developing voltage is set higher. With the applied developing voltage kept constant, the amount of carrier flying decreases as the ambient temperature and humidity decrease. Thus, even if the upper limit value of the developing voltage is set higher, it is possible to suppress the effect on the transferred image. On the other hand, when the ambient temperature and humidity increase, with the applied developing voltage kept constant, the amount of carrier flying increases and the effect on the transferred image becomes greater. Thus, it is preferable that the upper limit value of the developing voltage be set lower as the ambient temperature and humidity increase.

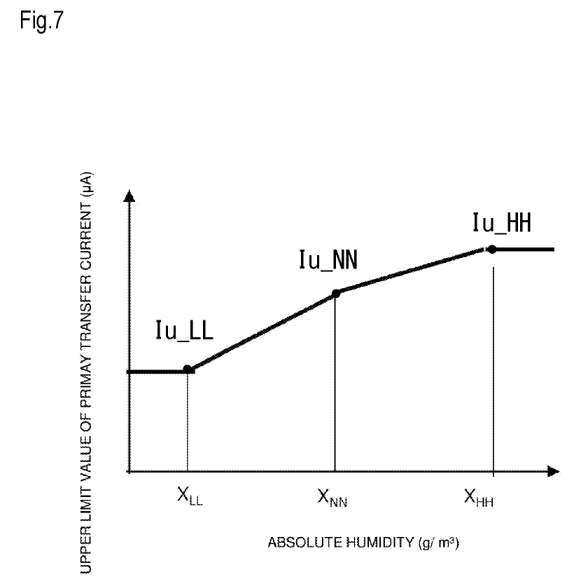

FIG. 7 is a graph showing the relationship between absolute humidity (g/ m³) and the upper limit value of the primary transfer current (transfer current). When the image formation mode is performed, based on the sensing result from the environment sensing portion (sensing portion) 46, the upper limit value of the primary transfer current is set. This allows the setting of the upper limit value of the primary transfer current (transfer current) according to the toner charge amount that changes with the ambient temperature and humidity. It is thus possible to suppress the effect of the toner charge amount and thereby prevent a rough image.

Specifically, as the ambient humidity decreases, the upper limit value of the primary transfer current (transfer current) is set lower. This helps suppress an increase in the toner charge amount and thereby prevent a rough image. On the other hand, as the ambient humidity increases, the upper limit value of the primary transfer current (transfer current) is set higher. Controlling the primary transfer current to equal to or less than the upper limit value based on the sensing result from the environment sensing portion (sensing portion) 46 helps prevent a rough image. The upper limit values of the developing voltage and the primary transfer current shown in FIGS. 6 and 7 are previously stored in the storage portion 70 according to the absolute humidity.

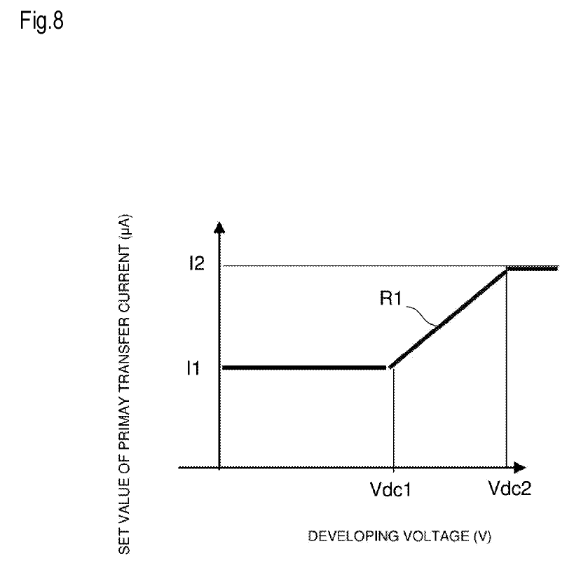

FIG. 8 is a graph showing the relationship, in a normal-temperature normal-humidity environment, between developing voltage and primary transfer current (transfer current). The graph in FIG. 8 is a relational expression R1 between developing voltage and primary transfer current, which is previously stored in the storage portion 70 according to the absolute humidity. In the embodiment, the relational expression R1 is given as a linear function. The relational expression R1 is calculated based on the upper limit value of the developing voltage determined based on the sensing result from the environment sensing portion (sensing portion) 46 and the lower and upper limit values of the transfer current.

More specifically, I1 in the relational expression R1 is the lower limit value of the transfer current to prevent a rough image as corrected based on the sensing result from the environment sensing portion (sensing portion) 46 (in a normal-temperature normal-humidity environment). As shown in FIG. 5, for the lower limit value of the transfer current, it is preferable to correct the transfer voltage (transfer current) to make it lower as the ambient humidity decreases. Vdc1 is the lower limit value of the developing voltage at which white spots can be prevented when a transfer current of I1 is output.

As shown in FIG. 6, Vdc2 is the upper limit value (Vdc_NN) of the developing voltage set based on the sensing result from the environment sensing portion (sensing portion) 46 (in a normal-temperature normal-humidity environment). As shown in FIG. 7, I2 is the upper limit value (Iu_NN) of the transfer current set based on the sensing result from the environment sensing portion (sensing portion) 46 (in a normal-temperature normal-humidity environment).

For example, the lower limit value I1 of the primary transfer current and the corresponding lower limit value Vdc1 of the developing voltage allow output at a predetermined image density with no deterioration in toner. Furthermore, the upper limit value Vdc2 of the developing voltage and the corresponding upper limit value I2 of the primary transfer current allow output at a predetermined image density in image formation performed by intermittent operation at a low printing ratio.

In the image formation mode, the developing voltage determined in the calibration mode is substituted in the relational expression R1 to determine the primary transfer current. That is, the image formation conditions in the image formation mode are determined by the relational expression R1 and the developing voltage determined in the calibration mode.

Specifically, if the developing voltage determined in the calibration mode is higher than the upper limit value (Vdc_NN) of the developing voltage corrected according to the sensing result from the environment sensing portion (sensing portion) 46 (in a normal-temperature normal-humidity environment), the developing voltage applied in the image formation mode is determined to be the upper limit value (Vdc_NN) of the developing voltage. Furthermore, the transfer current applied in the image formation mode is determined to be the upper limit value (Iu_NN) of the transfer current.

On the other hand, if the developing voltage determined in the calibration mode is equal to or less than the upper limit value (Vdc_NN) of the developing voltage corrected according to the sensing result from the environment sensing portion (sensing portion) 46 (in a normal-temperature normal-humidity environment), the developing voltage applied in the image formation mode is determined to be the developing voltage determined in the calibration mode. Furthermore, the transfer current applied in the image formation mode is determined to be the value determined by substituting it in the relational expression R1.

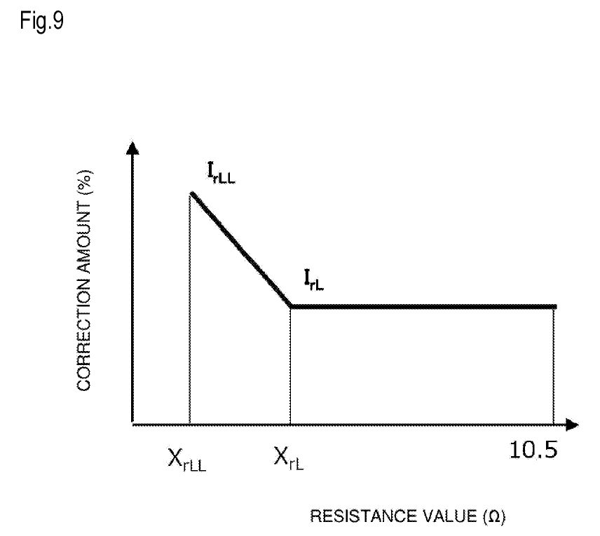

FIG. 9 is a graph showing the relationship between the surface resistance value (Ω) of the intermediate transfer belt 8 and the correction amount for the primary transfer current (transfer current). In the embodiment, based on the surface resistance value of the intermediate transfer belt (transfer destination member) 8 previously stored, the main control portion (control portion) 80 further corrects the primary transfer current. More specifically, if the surface resistance value of the intermediate transfer belt (transfer destination member) 8 is equal to or less than a predetermined value, as it decreases, the correction amount for the primary transfer current is increased. When a small patch image is transferred, the primary transfer current flowing into the patch image decreases. This makes it possible to more effectively prevent white spots. An initial value of the surface resistance value of the intermediate transfer belt 8 is previously stored in the storage portion 70 and is constant. For the surface resistance value of the intermediate transfer belt 8, no consideration is given to a change based on the sensing result from the environment sensing portion 46.

When the user enters a command to perform image formation, the main control portion 80 performs the image formation mode.

In the image formation mode, while the applied transfer voltage (transfer current) is controlled based on the relational expression R1 (see FIG. 8) between transfer current and developing voltage, image formation is performed. Meanwhile, the relational expression R1 is corrected based on the sensing result from the environment sensing portion (sensing portion) 46. That is, the image formation conditions in the image formation mode are corrected based on the sensing result from the environment sensing portion (sensing portion) 46. This helps prevent transfer failure according to the ambient environment of the apparatus body. It is thus possible to prevent white spots and a rough image and to output at an image density set at a target value.

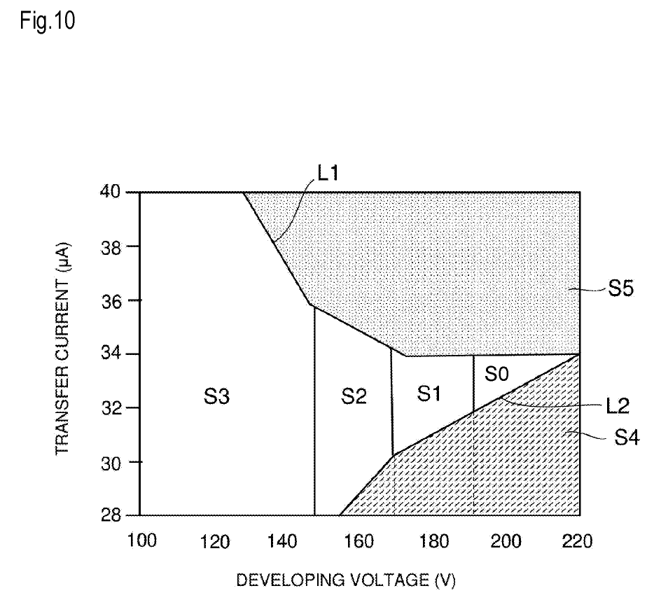

FIG. 10 is a graph showing the relationship, in a normal-temperature normal-humidity environment (RR environment, 25 °C, 50% RH), between developing voltage and primary transfer current (transfer current). L1 denotes the boundary beyond which a rough image falls outside the tolerable range, and L2 denotes the boundary beyond which an image with white spots falls outside the tolerable range. Specifically, in region S5 above the boundary line L1, a rough image falls outside the tolerable range. In region S4 below the boundary line L2, an image with white spots falls outside the tolerable range.

An image with white spots is judged to fall outside the tolerable range if a predetermined number or more white spots are found, for example, when a solid cyan image is formed. A rough image is judged to fall outside the tolerable range if roughness resulting from transfer failure of cyan disposed downstream in the traveling direction of the intermediate transfer belt 8 is observed, for example, when a green image is formed by superimposing yellow and cyan on each other.

The regions S0 to S3 (white regions) surrounded by the boundary lines L1 and L2 are OWs (operation windows, designable ranges) of developing voltage and primary transfer current at varying target values of the image density (I. D : image density). The region S0 is the OW when the target value of the image density is set at 1.45. The regions S0 and S1 are the OWs when the target value of the image density is set at 1.35. The regions S0, S1, and S2 are the OWs when the target value of the image density is set at 1.25.

If the target value of the image density is set at 1.45, the upper limit value of the developing voltage is set at 220 V, and its lower limit value is set at 190 V.

If the target value of the image density is changed, the image formation conditions in the image formation mode also change. If the target value of the image density is set at 1.35, the lower limit value of the developing voltage is set at 170 V.

If the target value of the image density is set at 1.25, the lower limit value of the developing voltage is set at 150 V. Here, if the developing voltage is equal to or less than a predetermined value (in the embodiment, 155 V), the lower limit value of the primary transfer current is fixed at 28 (μA).

If a primary transfer current smaller than the lower limit value of the primary transfer current (28 (μA)) is applied, even if the developing voltage is set higher than 150 V, an image with white spots is formed.

While FIG. 10 shows the relationship, in a normal-temperature normal-humidity environment (RR environment, 25 °C, 50% RH), between developing voltage and primary transfer current (transfer current), as the environment differs, the graph showing the relationship between developing voltage and primary transfer current also changes. In the embodiment, graphs corresponding to the sensing results from the environment sensing portion (sensing portion) 46 (for example, graphs corresponding to a high-temperature high-humidity environment and to a low-temperature low-humidity environment) are previously stored in the storage portion 70. And, with reference to the graph corresponding to the sensing result from the environment sensing portion (sensing portion) 46, image formation is performed under image formation conditions that fall within a predetermined OW (operation window, designable range).

When the job in the image formation mode ends, it is judged whether it is time to perform the calibration mode stored in the storage portion 70. Whether it is the time to perform the calibration mode is judged, for example, by checking whether the cumulative number of sheets printed after the previously performed calibration mode is equal to or more than a predetermined number (for example, 50 K). Performing the calibration mode after the end of the image formation mode helps reduce the waiting time for the user. The calibration mode may be initially performed when the power is turned on for the first time after shipment.

The developing voltage determined in the calibration mode is stored in the storage portion 70 and the calibration mode is ended. When the image formation mode is performed next, image formation is performed with the applied developing and transfer voltages corrected based on the developing voltage determined in the calibration mode.

The embodiment described above is not meant to limit the scope of the present disclosure, which thus allows for any modifications without departure from the spirit of what is disclosed herein. While the embodiment described above deals with, as an example of an image forming apparatus 100, a color printer as shown in FIG. 1, this is not meant as any limitation and it can instead be any other image forming apparatus such as a monochrome or color copier, a digital multifunction peripheral, or a facsimile machine.

What is claimed is:

1. An image forming apparatus comprising:
an image forming portion having:
an image carrying member having a photosensitive layer formed on a surface thereof;
a charging device that electrostatically charges the image carrying member;
an exposure device that forms an electrostatic latent image by exposing to light the image carrying member electrostatically charged by the charging device; and
a developing device disposed to face the image carrying member, the developing device having a developer carrying member carrying two-component developer containing magnetic carrier and toner, the developing device forming a toner image by attaching the toner to the electrostatic latent image formed on the image carrying member;
a transfer member disposed to face the image carrying member, the transfer member being fed with a predetermined transfer voltage to transfer to a transfer destination member the toner image formed on the image carrying member;
a sensing portion that senses humidity around an apparatus body;
a developing voltage power supply that applies a developing voltage to the developer carrying member;
a transfer voltage power supply that applies a transfer voltage to the transfer member to pass a transfer current across the transfer member; and
a control portion that controls the image forming portion, the sensing portion, the developing voltage power supply, and the transfer voltage power supply,
wherein
the control portion is operable to perform
a calibration mode in which predetermined image formation conditions are determined to keep image quality of a toner image, and
an image formation mode in which image formation is performed while the image formation conditions determined in the calibration mode are corrected,
if the developing voltage determined in the calibration mode is equal to or less than a predetermined value, the control portion does not correct the image formation conditions based on a sensing result from the sensing portion,
if the developing voltage determined in the calibration mode is higher than the predetermined value, the control portion corrects the image formation conditions based on the sensing result from the sensing portion, and
the image formation conditions are corrected based on the sensing result from the sensing portion.

2. The image forming apparatus according to claim 1, wherein
the image formation conditions are determined based on
a relational expression between the developing voltage and the transfer current, the relational expression being calculated based on an upper limit value of the developing voltage determined based on the sensing result from the sensing portion and a lower and an upper limit value of the transfer current, and
the developing voltage determined in the calibration mode.

3. The image forming apparatus according to claim 1, wherein
based on a previously stored surface resistance value of the transfer destination member, the control portion further corrects the transfer current.

4. The image forming apparatus according to claim 1, wherein
a plurality of transfer rollers are disposed,
the image carrying member disposed most downstream in a traveling direction of the transfer destination member develops the toner image of black,
a rotation shaft of the transfer roller disposed most downstream in the traveling direction of the transfer destination member is offset downstream in the traveling direction of the transfer destination member from right above a rotation shaft of the corresponding image carrying member, and
a rotation shaft of at least one transfer roller disposed upstream of the transfer roller disposed most downstream in the traveling direction of the transfer destination member is offset upstream in the traveling direction of the transfer destination member from right above a rotation shaft of the corresponding image carrying member.

5. The image forming apparatus according to claim 1, wherein
the photosensitive layer is formed of amorphous silicon.
